(19) United States
(12) Patent Application Publication
(10) Pub. No.: US 2026/0223142 A1
(43) Pub. Date: Jul. 30, 2026

(54) HARQ-ACK CONFIGURATIONS FOR WIRELESS COMMUNICATIONS

(71) Applicant: ZTE Corporation, Shenzhen (CN)

(72) Inventors: Shuaihua KOU, Shenzhen (CN); Xing LIU, Shenzhen (CN); Wei GOU, Shenzhen (CN); Xianghui HAN, Shenzhen (CN); Xingguang WEI, Shenzhen (CN)

(73) Assignee: ZTE Corporation, Shenzhen (CN)

(21) Appl. No.: 19/573,597

(22) Filed: Mar. 20, 2026

Related U.S. Application Data
(63) Continuation of application No. PCT/CN2023/121085, filed on Sep. 25, 2023.

(51) Int. Cl. H04W 72/30; H04L 1/1812; H04W 72/0453

(52) U.S. Cl. CPC H04W 72/30; H04L 1/1812; H04W 72/0453

(57) ABSTRACT

This document generally relates to wireless communication that includes a network device that sends at least one of a first configuration for a unicast transmission or a second configuration for a multicast transmission to a user device. The user device receives at least one of the first configuration or the second configuration. In addition, the network device 104 sends, and the user device receives, at least one of the unicast transmission or the multicast transmission to the user device. Also, the user device generates a hybrid automatic repeat request (HARQ)-acknowledgment (ACK) that includes information bits determined based on the first configuration or the second configuration. The user device sends and the network device receives the HARQ-ACK.

### CROSS-REFERENCE TO RELATED APPLICATION(S)

This application is a continuation of International Patent Application No. PCT/CN2023/121085, filed Sep. 25, 2023. The contents of International Patent Application No. PCT/CN2023/121085 are herein incorporated by reference in their entirety.

### TECHNICAL FIELD

This document is directed generally to HARQ-ACK configurations in wireless communications.

### BACKGROUND

In wireless communication systems, the network may provide one or more services for a user device. Different services may have different quality of service (QoS) requirements. To meet the different QoS requirements, different numbers of repetitions may be configured for different services. However, due to the different numbers, the ability to generate a hybrid automatic repeat request (HARQ)-acknowledgement (ACK) codebook when the user devices receives one or more services may be problematic. Ways to remedy such issues may be desirable.

### SUMMARY

This document relates to methods, systems, apparatuses and devices for wireless communication. In some implementations, a method for wireless communication includes: sending, by a network device, at least one of a first configuration for a unicast transmission or a second configuration for a multicast transmission to a user device; sending, by the network device, at least one of the unicast transmission or the multicast transmission to the user device; and receiving, by the network device, a hybrid automatic repeat request (HARQ)-acknowledgment (ACK) comprising information bits determined based on the first configuration or the second configuration.

In some other implementations, a method for wireless communication includes: receiving, by a user device, at least one of a first configuration for a unicast transmission or a second configuration for a multicast transmission; receiving, by the user device, at least one of the unicast transmission or the multicast transmission; generating, by the user device, a hybrid automatic repeat request (HARQ)-acknowledgement (ACK) for the unicast transmission or for the multicast transmission, the HARQ-ACK comprising information bits determined based on the first configuration or the second configuration; and transmitting, by the user device, the HARQ-ACK.

In some other implementations, a device, such as a network device, is disclosed. The device may include one or more processors and one or more memories, wherein the one or more processors are configured to read computer code from the one or more memories to implement any of the methods above. In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method for wireless communication.

FIG. 3 shows a flow chart of a method for wireless communication.

FIG. 4 shows a schematic diagram of an example of candidate slot set determination.

FIG. 5 shows a schematic diagram of another example for candidate slot determination.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols, e.g., 6G or beyond.

The present description describes various embodiments of systems, apparatuses, devices, and methods for wireless communications related to hybrid automatic repeat request (HARQ)-acknowledgement (ACK) configurations.

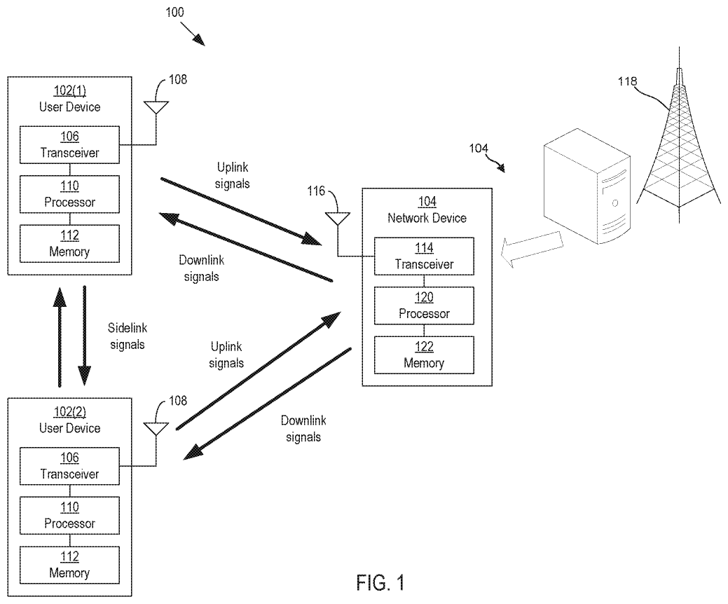

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one network device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

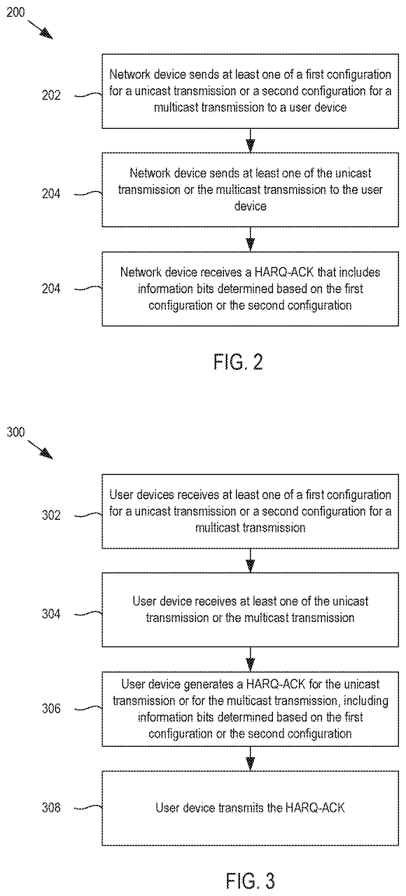

FIG. 2 shows a flow chart of an example method 200 for wireless communication that involves hybrid automatic repeat request (HARQ)-acknowledgement (ACK) for unicast and/or multicast transmissions. At block 202, a network device 104 may send at least one of a first configuration for a unicast transmission or a second configuration for a multicast transmission to a user device 102. At block 204, the network device 204 may send at least one of the unicast transmission or the multicast transmission to the user device 102. At block 206, the network device 104 may receive a HARQ-ACK that includes information bits determined based on the first configuration or the second configuration.

FIG. 3 shows a flow chart of another example method 300 for wireless communication that involves hybrid automatic repeat request (HARQ)-acknowledgement (ACK) for unicast and/or multicast transmissions. At block 302, a user device 102 may receive at least one of a first configuration for a unicast transmission or a second configuration for a multicast transmission. At block 304, the user device 102 may receive at least one of the unicast transmission or the multicast transmission. At block 306, the user device 102 may generate a HARQ-ACK for the unicast transmission or for the multicast transmission. The HARQ-ACK may include information bits determined based on the first configuration or the second configuration. At block 308, the user device 102 may transmit the HARQ-ACK.

In some implementations of the method 200 and/or the method 300, at least one of the first configuration or the second configuration includes one or more numbers of repetitions for a physical downlink shared channel (PDSCH), where each of the one or more numbers of repetitions of the second configuration is for a multicast service. For some of these implementations, each of the one or more numbers of repetitions comprises at least one of: a number of repetitions for dynamic scheduling of the PDSCH; a number of repetitions for a semi-persistent PDSCH; or a number of repetitions included in a time domain resource allocations (TDRA) table. In addition or alternatively, the user device 102 may determine whether a time domain resource allocations (TDRA) configuration is included in a TDRA set for a slot based on N consecutive slots. In some implementations, the determination of whether the TDRA configuration is included in the TDRA set for the slot based on N consecutive slots includes: determining that the TDRA configuration is not included in the TDRA set in response to at least one symbol of the TDRA configuration in each of N consecutive slots being an uplink symbol; and determining that the TDRA configuration is included in the TDRA set in response to at least one symbol of the TRDRA configuration in each of N consecutive slots not being an uplink symbol, and wherein the slot is a last slot of the N consecutive slots. In some of these implementations, at least one of: N is a maximum value among all numbers of repetitions in the first configuration for HARQ-ACK information bit generation for unicast transmissions and is a maximum value among all numbers of repetitions in the second configuration for HARQ-ACK information bit generation for multicast transmissions; N is a maximum value among all numbers of repetitions in the first configuration and the second configuration for HARQ-ACK information bit generation; N is a maximum value among all numbers of repetitions in the first configuration and the slot is determined based on a time interval that belongs to a first time interval set for the unicast transmissions and does not belong to a second time interval set for the multicast transmissions; N is a maximum value among all numbers of repetitions in the second configuration and the slot is determined based on a time interval that belongs to the second time interval set for the multicast transmissions and does not belong to the first time interval set for the unicast transmissions; N is a maximum value among all numbers of repetitions in the first configuration and the second configuration, and the slot is determined based on a time interval that belong to the first time interval set for the unicast transmissions and also belong to the second time interval set for the multicast transmissions; or N is a maximum value among all numbers of repetitions for the TDRA configuration.

In some implementations of the method 200 and/or the method 30, at least one of the first configuration or the second configuration includes at least one of: a codeblock group (CBG) transmission, a transport block (TB)-based transmission, or a number of CBGs. In some of these implementations, the user device 102 generates the information bits of the HARQ-ACK per CBG in response to the first configuration or the second configuration includes the CBG transmission. In addition or alternatively, the user device 102 generates the information bits of the HARQ-ACK per TB in response to the first configuration or the second configuration including the TB transmission. In addition or alternatively, the user device 102 generates the information bits of the HARQ-ACK per CBG for a slot determined based on a time interval that belongs to the first time interval set for the unicast transmissions. In addition or alternatively, the user device 102 generates the information bits of the HARQ-ACK bits per TB for a slot determined based on a time interval that belongs to the second time interval set for the multicast transmissions and does not belong to the first time interval set for the unicast transmission.

Further details, any or all of which may be implemented in any of various embodiments of the method 200, the method 300, and/or other methods, is now described.

In some implementations, the network device 104 may configure one or more multicast or broadcast services (MBS) for a user device 102. In the present description for simplicity, the term multicast is used to refer to both multicast and broadcast, unless expressly described otherwise.

Also, in the wireless communication system 100, a time domain resource allocations (TDRA) table for a data channel may include one or more rows. A row may include a TDRA configuration, where the configuration may include at least one of a time domain resource in a slot, a mapping type, or an offset between the data channel and control information (e.g., a DCI). In addition, the number of repetitions or the number of slots for a transport block over multiple slots (TBoMS) transmission may be configured for (or included in) at least one of the TDRA configurations. In the present description, the embodiments are described herein for data channel transmission repetition, although they may be similarly applicable to other types of transmission, such as TBoMS transmissions, where the number of repetitions may be replaced by the number of slots for TBoMS transmission.

Additionally, a time domain resource in a slot may include at least one of the number of orthogonal frequency division multiplexing (OFDM) symbols and a starting OFDM symbol. The different number of repetitions or different number of slots may be configured for different TDRA configurations.

Additionally, a hybrid automatic repeat request (HARQ)-acknowledgment (ACK) codebook may include HARQ-ACK information bits for one or more data channels. As described, a data channels may include a physical downlink shared channel (PDSCH), a physical uplink shared channel (PUSCH), or a physical sidelink shared channel (PSSCH).

Additionally, in some implementations, a HARQ-ACK codebook may be transmitted on a first slot (or a first sub-slot). In the present description, the embodiments for the HARQ-ACK codebook are described as being transmitted on a slot, although they may be similarly applied to embodiments where the HARQ-ACK codebook is transmitted on a sub-slot.

Additionally, in some implementations, a HARQ-ACK codebook may include HARQ-ACK information bits for a candidate slot set. The candidate slot set may correspond to the first slot. One or more time intervals (such as a plurality of time intervals) may be used to determine the candidate slot set. The time interval may be or include one or more slots. Also, the time interval may be between the slot of the data channel (or a last slot of the data channel) and the slot of the HARQ-ACK information for the data channel. The plurality of time intervals may be configured by the network device 104 or specified by the protocol or specification according to which the communication nodes in the wireless communication system 100 are configured to operate. Additionally, a candidate slot set may include one or more slots with an offset between each of the one or more slots, and the first slot being equal to any one of the plurality of time intervals. In other words, if the offset between a slot and the first slot is equal to any one of the plurality of time intervals, the slot may belong to the candidate slot set.

Additionally or alternatively, whether the slot may be used for data channel transmission may be considered to determine the candidate slot set. If the slot may not be able to be used for data channel transmission, then the slot may not belong to the candidate slot set even though the offset between the slot and the first slot is equal to any one of the plurality of time intervals. If the offset between a slot and the first slot is equal to any one of the plurality of time intervals and the slot may be used for data channel transmission, then the slot may belong to the candidate slot set.

In general, the user device 102 may first determine a plurality of slots that satisfy the requirement of the time interval (e.g., the offset between any of the plurality of slots and the first slot is equal to any one of the plurality of time intervals). In turn, the user device 102 may determine whether each slot in the plurality of slots is valid (or whether the slot can be used for data channel transmission) one by one. If a slot is not valid, then the slot may not be included in the candidate slot set. Otherwise, if the slot is valid, then the slot may be included in the candidate slot set. In particular of these implementations, if the slot has the available resource for data channel transmission, the slot may be considered as valid and included in the candidate slot set. If the slot does not have the available resource for data channel transmission, the slot may be considered as invalid and may not be included in the candidate slot set.

In addition or alternatively, the data channel repetition may be configured. The number of repetitions may be used to determine whether a slot is valid. A plurality of consecutive slots may be used to determine whether a slot is valid. The slot may be the last slot of the plurality of consecutive slots. For a specific slot in the plurality of slots, the user device 102 may determine whether the plurality of consecutive slots have an available resource for data transmission. If any one of the plurality of consecutive slots ending with the specific slot (e.g., the specific slot is the last slot of the plurality of consecutive slots) has an available resource for transmitting the data channel, the specific candidate slot may be considered as valid and included in the candidate slot set. If none of the plurality of consecutive slots ending with the specific slot (e.g., the specific slot is the last slot of the plurality of consecutive slots) has an available resource for transmitting the data channel, the specific slot may be considered as invalid and may not be included in the candidate slot set.

In some implementations, a TDRA configuration may be used to determine whether a slot is valid. For at least some implementations, such as where the wireless communication system 100 is configured in accordance with NR, to determine whether a slot is valid (or can be used for data channel transmission), a valid TDRA configuration for the slot may be determined first.

Additionally, in some implementations, a first set may include all of the TDRA configurations for the data channel that may be used for the user device 102. For example, the first set may include the plurality of TDRA configurations in the TDRA tables configured by the network device 104 and/or the default TDRA configuration defined by the protocol, or a combination of them. The user device 102 may determine whether these TDRA configurations in the first set are valid for a slot one by one. If a TDRA configuration may not be valid, then the TDRA configuration may be excluded from the first set for the slot. If a TDRA configuration may be valid, then the TDRA configuration may be kept in the first set for the slot. In other words, the user device 102 may determine whether these TDRA configurations are kept in the first set for a slot one by one.

Additionally, in some implementations, for a TDRA configuration for a slot, if there is at least one symbol in the TDRA configuration that cannot be used for data channel transmission, the TDRA configuration may be considered as an invalid configuration. For example, an uplink (UL) symbol may not be able to be used for downlink (DL) transmission and a DL symbol or a flexible symbol may be able to be used for downlink transmission. For downlink transmission, if at least one symbol in the TDRA configuration is an UL symbol, the TDRA configuration may be considered as invalid configuration. In turn, the invalid TDRA configuration may be excluded from the first set for the slot. Otherwise, if all of the symbols in the TDRA configuration are not uplink symbols, or each of the symbols in the TDRA configuration is a DL symbol or a flexible symbol, then the TDRA configuration may be considered as valid. In turn, the valid TDRA configuration may be kept in the first set for the slot.

Additionally, in some implementations, the number of repetitions may be used to determine the candidate slot set. More specifically, the number of repetitions may be used to determine whether a TDRA configuration is valid. For a specific slot, the UE may determine whether a TDRA configuration is valid in the plurality of consecutive slots (e.g., whether the plurality of consecutive slots have available resource for data channel transmission with the TDRA configuration). If the TDRA configuration is valid in at least one of the plurality of consecutive slots (e.g., at least one of the plurality of consecutive slots has available resource for data channel transmission with the TDRA configuration), the TDRA configuration may be considered as valid. Otherwise (e.g., the TDRA configuration is not valid in all of the plurality of consecutive slots or all of the plurality of consecutive slots does not have available resource for data channel transmission with the TDRA configuration), the TDRA configuration may not be valid.

As an example, suppose the number of repetitions is Y. The user device 102 may determine whether the TDRA configuration is valid in Y consecutive slots. For a downlink transmission, for a slot n, if at least one symbol in the TDRA configuration in each of slots from slot n−Y+1 to slot n is an UL symbol, the TDRA configuration may be considered as an invalid TDRA configuration for slot n. Then this TDRA configuration may be excluded from the first set for slot n. Otherwise (e.g., all of the symbols of the TDRA configuration in at least one of the slots from slot n−Y+1 to slot n are DL symbols or flexible symbols), this TDRA configuration may be considered as valid and kept in the first set for slot n.

After finishing the validation determination of all the TDRA configurations in the first set for a slot, if the first set is not empty set (e.g., there is at least one valid TDRA configuration left in the first set), then the corresponding slot may be valid and included in the candidate slot set. If the set is an empty set (e.g., there is no valid TDRA configuration left in the set), then the corresponding slot may not be valid and not be included in the candidate slot set.

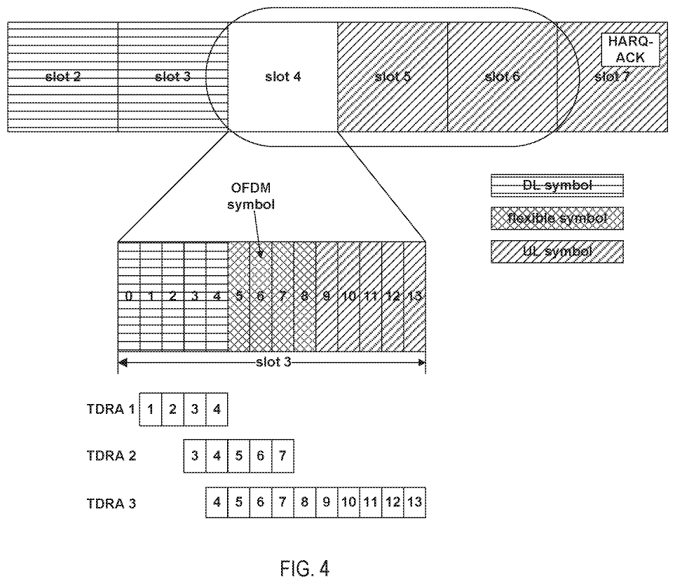

FIG. 4 shows a schematic diagram of an example of candidate slot set determination. The example shows six slots, denoted by slots 2-7. Each slot may include 14 OFDM symbols, denoted by symbols 0-13, respectively. Slot 2 and slot 3 may include only DL symbols. Slot 5, slot 6 and slot 7 may include only UL symbols. In slot 4, the first 5 symbols (e.g., symbols 0-4) may be DL symbols, and the next 4 symbols (e.g., symbols 5-8) may be flexible symbols, and the last 5 symbols (e.g., symbols 9-13) may be UL symbols.

Further, in the example in FIG. 4, the HARQ-ACK codebook may be transmitted on slot 7. The plurality of time intervals may include 1 slot, 2 slots, and 3 slots. The offset between slots 3-6 and slot 4 may be 4, 3, 2, and 1, respectively. Only slot 4, slot 5 and slot 6 may satisfy the requirement of the time interval. Therefore, the plurality of the slots corresponding to slot 7 includes slot 4, slot 5 and slot 6. In turn, the user device 102 may further determine the candidate slot set from slot 4, slot 5 and slot 6.

Additionally, in the example in FIG. 4, suppose there are three TDRA configurations in total, denoted by TDRA 1-3. In TDRA 1, four OFDM symbols from symbol 1 to symbol 4 may be included. In TDRA 2, five symbols from symbol 3 to symbol 7 may be included. In TDRA 3, ten symbols from symbol 4 to symbol 13 may be included.

Additionally, in the example in FIG. 4, the number of repetitions for the data channel is two. Correspondingly, the number or value of two is used to determine whether a TDRA configuration is valid for a slot. For example, the user device 102 may determine whether the TDRA configuration is valid in two consecutive slots.

Additionally, in the example in FIG. 4, for slot 4, the user device 102 may determine whether the TDRA configuration is valid in slot 3 and slot 4. All of the symbols of TDRA 1 (e.g., from symbol 1 to 4) in slot 3 or slot 4 are DL symbols. Therefore, TDRA 1 is valid for slot 4 and is included in the first set. All of the symbols of TDRA 2 (e.g., from symbol 3 to symbol 7) in slot 3 or slot 4 are DL symbols or flexible symbols. Therefore, TDRA 2 is valid for slot 4 and is included in the first set. All of the symbols of TDRA 3 (e.g., from symbol 4 to symbol 13) in slot 3 are DL symbols. Therefore, TDRA 3 is valid for slot 4 and is included in the first set. Therefore, the first set for slot 4 includes TDRA 1, TDRA 2, and TDRA 3. Slot 4 may be included in the candidate slot set.

Additionally, in the example in FIG. 4, for slot 5, the user device 102 may determine whether the TDRA configuration is valid in slot 4 and slot 5. All the symbols of TDRA 1 (e.g., from symbol #1 to #4) in slot 4 are DL symbols. Therefore, TDRA 1 is valid for slot 5 and should be included in the first set. All the symbols of TDRA 2 (e.g., from symbol #3 to symbol #7) in slot 4 are DL symbols or flexible symbols. Therefore, TDRA 2 is valid for slot 5 and should be included in the first set. Not all the symbols of TDRA 3 (e.g., from symbol #4 to symbol #13) in slot 4 or slot 5 are DL symbols or flexible symbols. In other words, at least one of the symbols of TDRA 2 in each of slot 4 and slot 5 is UL symbol. Therefore, TDRA 3 is invalid for slot 5 and may not be included in the first set. Therefore, the first set for slot 4 includes TDRA 1 and TDRA 2. Since there are valid TDRA configurations in the first set for slot 5, slot 5 may be included in the candidate slot set.

Additionally, in the example in FIG. 4, for slot 6, the user device 102 may determine whether the TDRA configuration is valid in slot 5 and slot 6. All the symbols of TDRA 1 (e.g., from symbol 1 to 4) in slot 5 and slot 6 are UL symbols. This means at least one of the symbols of TDRA 1 in each of slot 5 and slot 6 is a UL symbol. Therefore, TDRA 1 may be invalid for slot 6 and may not be included in the first set. All of the symbols of TDRA 2 (e.g., from symbol 3 to symbol #) in slot 5 and slot 6 are UL symbols. This means at least one of the symbols of TDRA 2 in each of slot 5 and slot 6 is a UL symbol. Therefore, TDRA 2 may be invalid for slot 6 and may not be included in the first set. All of the symbols of TDRA 3 (e.g., from symbol 4 to symbol 13) in slot 5 and slot 6 are UL symbols. This means at least one of the symbols of TDRA 3 in each of slot 5 and slot 6 is an UL symbol. Therefore, TDRA 3 may be invalid for slot 6 and may not be included in the first set. Correspondingly, there may be no valid TDRA configuration in the first set for slot 6, and in turn, slot 6 may not be included in the candidate slot set. Additionally, the user device 102 may determine that the candidate slot may include slot 4 and slot 5 corresponding to the HARQ-ACK codebook on slot 6.

Additionally, in some implementations, for each slot in the candidate slot set, the user device 102 may generate one or more HARQ-ACK information bits. In addition or alternatively, there may be one or more start and length indicator value (SLIV) groups for a slot in the candidate slot set. The user device 102 may generate one or more HARQ-ACK information bits for a SLIV group. The user device 102 may transmit the generated HARQ-ACK information bits to the network on the first slot.

Additionally, in some implementations, the network device 104 may configure data channel repetitions (or data channel aggregation) for a user device 102 for unicast transmission and/or multicast transmission. The network device 104 may configure the number of the repetitions for the data channel transmission for unicast transmission and/or for multicast transmission.

A first number of repetitions may be determined for unicast transmission. The first number of repetitions may be the maximum (or largest) value among the number of repetitions that the network device 104 configures for the user device 102 for the unicast transmission. The first number the repetitions may be the maximum (or largest) one of: the number of repetitions for dynamic scheduling of data channel transmission for unicast transmission (if any), the number of repetitions for semi-persistent scheduling of data channel transmission for unicast transmission (if any), and all of the numbers of repetitions included in a TDRA table for the data channel for unicast transmission (if any). The number of repetitions for the dynamic scheduling data channel transmission, the number of the repetitions for semi-persistent scheduling of data channel transmission, and/or the number of the repetitions included in the TDRA table for unicast transmission may be configured by the network device 104 for the user device 102.

For example, the network device 104 may configure a number of repetitions for dynamic scheduling of data channel transmission may be N1 (where N1 is an integer greater than 0). The network device 104 may configure the number of repetitions for semi-persistent scheduling of data channel transmission to be N2 (where N2 is an integer greater than 0). In turn, the first number of repetitions for unicast transmission may be the larger of N1 and N2.

As another example, the network device 104 may configure a TDRA table with four rows for the user device 102 for the unicast transmission. The number of repetitions in the first row, the second row, and the fourth row may be N3, N4, N5, respectively. The first number of repetitions for unicast transmission may be the maximum value (or largest one) of N3, N4, and N5.

In addition, in some implementations, the network device 104 may configure both the number of repetitions for dynamic scheduling of a data channel (N1) and the TDRA table for the user device 102 for unicast transmission. The first number of repetitions may be the maximum value (or largest one) of N1, N3, N4, and N5.

Additionally, a second number of repetitions may be determined for multicast. In a similar manner as for unicast transmission, the second number of repetitions may be the maximum (or largest) value of the number of repetitions that the network device 104 may configure for the user device 102 for the multicast transmission. Similarly, the second number the repetitions may be the maximum (or largest) one of the number of repetitions for dynamic scheduling of data channel transmission for multicast transmission (if any), the number of repetitions for a semi-persistent scheduling of data channel transmission for multicast transmission (if any), and all the numbers of repetitions included in the TDRA table for the data channel for multicast transmission (if any). The multicast transmission may be one or more MBS in any of various implementations. Additionally, in some implementations, the network 104 may configure more than one MBS for the user device 102. The network 104 may configure the number of repetitions for each of the more than one MBS. The second number of repetitions may be the maximum (or largest) value of the number of repetitions for the more than one MBS.

Additionally, in some implementations, the user device 102 may use the larger one (e.g., maximum value) of the first number of repetitions and the second number of repetitions to determine the candidate slot set (e.g., to determine whether a TDRA configuration is valid or kept in the first set) in accordance with the embodiments. The TDRA configuration may be used for data channel for unicast transmission and/or multicast transmission. That is to say Y may be the larger one of the first number of repetitions and the second number of repetitions in the procedure of determining whether the TDRA configuration is valid in accordance with the embodiments.

In some implementations, a first set of one or more time intervals may be for unicast. A second set of one or more time intervals may be for multicast. In some embodiments, the network device 104 may configure a first HARQ-ACK feedback mode for the user device 102. A third set of one or more time intervals may include a time interval that belongs to the first set of one or more time intervals but does not belong to the second set of one or more time intervals. A fourth set of one or more time intervals may include an interval that belongs to the second set of one or more time intervals but does not belong to the first set of one or more time intervals. A fifth set of one or more time intervals may include time intervals that belong to both the first set and the second set. For example, the first set of one or more time intervals may include slot offsets {0, 1, 3, 5, 6, 7, 8}. The second set of one or more time intervals may include slot offsets {3, 4, 5, 8, 9, 10}. The slot offsets {0, 1, 6, 7} may belong to the first set of one or more time intervals and does not belong the second set of one or more time intervals. The third set of one or more time intervals may include slot offsets {0, 1, 6, 7}. The slot offsets {4, 9, 10} belong to the second set of one or more time intervals and does not belong to the first set of one or more time intervals. The fourth set of one or more time intervals may include slot offsets {4, 9, 10}. The slot offsets {3, 5, 8} belong to both the first set of one or more time intervals and the second set of one or more time intervals. The fifth set of one or more time intervals may include the slot offsets {3, 5, 8}.

In some implementations, the user device 102 may use the first number of repetitions and the third set of one or more time interval to determine a candidate slot set (e.g., to determine whether a TDRA configuration is valid or kept in the first set) for generating the HARQ-ACK information bits in accordance with the embodiments. In particular of these implementations, the user device 102 may use the third set of one or more time intervals to determine a first plurality of slots. The offset between each slot in the first plurality of slots and the first slot for HARQ-ACK transmission may be equal to any one of the third set of one or more time intervals. The user device 102 may use the first number of repetitions to determine the candidate slot set (e.g., to determine whether a TDRA configuration is valid or kept in the first set) from the first plurality of slots in accordance with the embodiments. The TDRA configuration may only be used for PDSCH for unicast transmission.

The user device 102 may use the second number of repetitions and the fourth set of one or more time intervals to determine the candidate slot set (e.g., to determine whether the TDRA configuration is valid or kept in the first set) for generating the HARQ-ACK information bits in accordance with the embodiments. In particular of these implementations, the user device 102 may use the fourth set of one or more time intervals to determine a second plurality of slots. The offset between each slot in the second plurality of slots and the first slot for HARQ-ACK transmission may be equal to any one of the fourth set of one or more time intervals. The user device 102 may use the second number of repetitions to determine the candidate slot set (e.g., to determine whether a TDRA configuration is valid or kept in the first set) from the second plurality of slots in accordance with the embodiments. The TDRA configuration may only be used for PDSCH for multicast transmission.

The user device 102 may use the fifth set of one or more time intervals and the larger one (e.g., maximum value) of the first number of repetitions and the second number of repetitions to determine the candidate slot set (e.g., to determine whether the TDRA configuration is valid or kept in the first set) for generating the HARQ-ACK information bits in accordance with the embodiments. In particular of these implementations, the user device 102 may use the fifth set of one or more time intervals to determine a third plurality of slots. The offset between each slot in the third plurality of slots and the first slot for HARQ-ACK transmission may be equal to any one of the fifth set of one or more time intervals. The user device 102 may use the larger one (e.g., maximum value) of the first number of repetitions and the second number of repetitions to determine the candidate slot set (e.g., to determine whether a TDRA configuration is valid or kept in the first set) from the third plurality of slots in accordance with the embodiments. The TDRA configuration may only be used for PDSCH for multicast transmission and/or unicast transmission. The user device 102 may concatenate the generated HARQ-ACK information bits to form a final HARQ-ACK codebook to be transmitted to the network device 104.

Additionally, in some implementations, the network device 104 may configure frequency division multiplexing (FDM) reception for the user device 102. The user device 102 may receive a PDSCH for multicast and a PDSCH for unicast overlapping in the time domain.

Additionally, in some implementations, the user device 102 may use the first number of repetitions to determine a candidate slot set (e.g., to determine whether TDRA configuration is valid or kept in the first set) for generating a first HARQ-ACK codebook for unicast transmission in accordance with the embodiments. The TDRA configuration may be for the data transmission for unicast transmission. The slot in the candidate slot may be determined based on the first set of one or more time intervals in accordance with the embodiments. The user device 102 may use the second number of repetitions to determine the candidate slot set (e.g., to determine whether TDRA configuration is valid or kept in the first set) for generating a second HARQ-ACK codebook for multicast transmission in accordance with the embodiments. The TDRA configuration may be for the data transmission for multicast transmission. The slot in the candidate slot may be determined based on the second set of one or more time intervals in accordance with the embodiments. The user device 102 may concatenate the first HARQ-ACK codebook and the second HARQ-ACK codebook to form a final HARQ-ACK codebook to be transmitted to the network device 104.

In some embodiments, the network device 104 may configure a second HARQ-ACK feedback mode for the user device 102. A sixth set of one or more time intervals may be a combination of the first set of one or more time intervals and the second set of one or more time intervals. In addition or alternatively, the set of one or more time intervals may include a time interval that belongs to the first set of one or more time intervals or belongs to the second set of one or more time intervals. For example, the first set of one or more time intervals may include slot offsets {0, 1, 3, 5, 6, 7, 8}. The second set of one or more time intervals may include slot offsets {3, 4, 5, 8, 9, 10}. The sixth set of one or more time intervals may include slot offsets {0, 1, 3, 5, 6, 7, 8, 4, 9, 10}. The user device 102 may use the sixth set of one or more time intervals and the larger one (e.g., maximum value) of the first number of repetitions and the second number of repetitions to determine the candidate slot set (e.g., to determine whether the TDRA configuration is valid or kept in the first set) for generating the HARQ-ACK information bits in accordance with the embodiments. In particular of these implementations, the user device 102 may use the sixth set of one or more time intervals to determine a fourth plurality of slots. The offset between each slot in the fourth plurality of slots and the first slot for HARQ-ACK transmission may be equal to any one of the sixth set of one or more time intervals. The user device 102 may use the larger one (e.g., maximum value) of the first number of repetitions and the second number of repetitions to determine the candidate slot set (e.g., to determine whether a TDRA configuration is valid or kept in the first set) from the fourth plurality of slots in accordance with the embodiments. The TDRA configuration may be used for PDSCH for multicast transmission and/or unicast transmission.

In some implementations, the user device 102 may use the first number of repetitions to determine the candidate slot set. In particular of these implementations, the user device 102 may use the largest number of repetitions for unicast transmission to determine whether the TDRA configuration is included in the first set for the slot (e.g., whether the TDRA configuration is valid for the slot). The network device 104 may configure the largest number of repetitions for unicast transmission (e.g., the first number of repetitions) to not be less than the largest number of repetitions for multicast transmission (e.g., second number of repetitions). From the perspective of the user device 102, the user device 102 does not expect to be configured with the largest number of repetitions for unicast transmission (e.g., the first number of repetitions) less than the largest number of repetitions for multicast transmission (e.g., second number of repetitions).

In some implementations, the user device 102 may use the second number of repetitions to determine the candidate slot set. More specifically, the user device 102 may use the largest number of repetitions for multicast transmission to determine whether the TDRA configuration is included in the first set for the slot (e.g., whether the TDRA configuration is valid for the slot). The network device 104 may configure the largest number of repetitions for multicast transmission (e.g., the second number of repetitions) to not be less than the largest number of repetitions for unicast transmission (e.g., the first number of repetitions). From the perspective of the user device 102, the user device 102 does not expect to be configured with the largest number of repetitions for unicast transmission (e.g., the first number of repetitions) greater than the largest number of repetitions for multicast transmission (e.g., second number of repetitions).

In some implementations, the network device 104 may configure that the largest number of repetitions for multicast transmission (e.g., the second number of repetitions) to be equal to the largest number of repetitions for unicast transmission (e.g., the first number of repetitions). From the perspective of the user device 102, the user device 102 may expect the largest number of repetitions for unicast transmission (e.g., the first number of repetitions) to be the same as the largest number of repetitions for multicast transmission (e.g., second number of repetitions). The user device 102 may use the first number of repetitions or the second number of repetitions to determine the candidate slot set.

### Embodiment 2

Additionally, in some implementations, the network device 104 may configure at least one TDRA table for unicast transmission or multicast transmission for the user device 102. The at least one table for unicast transmission may include a plurality of TDRA configurations. Each of the TDRA configurations may include a number of repetitions. The number of repetitions may be used to determine a candidate slot set. In particular of these implementations, the number of repetitions may be used to determine whether the corresponding TDRA configuration is valid for a slot. For at least some implementations, if the number of repetitions is not included in a TDRA configuration or is not configured, the number of repetitions for the TDRA configuration is one.

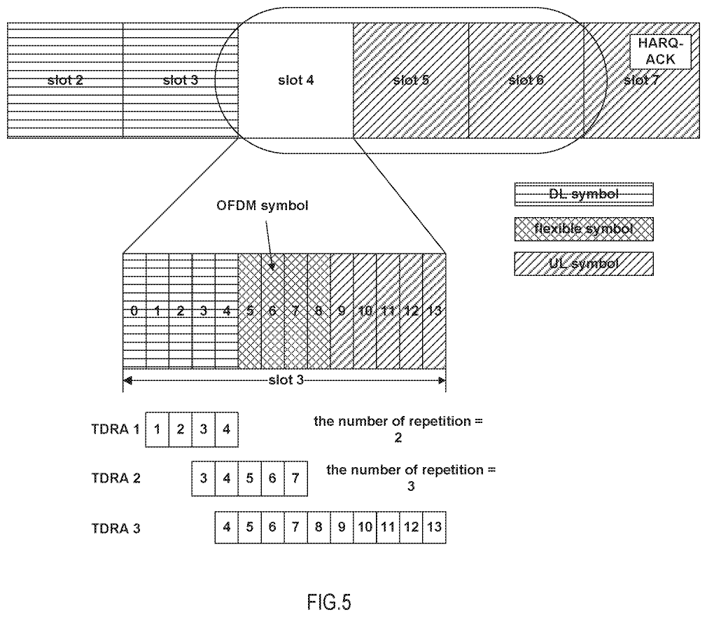

To illustrate, FIG. 5 is a schematic diagram of another example for candidate slot determination. As shown, the example in FIG. 5 uses similar configurations of TDRAs and slots, and correspondingly, description previously explained for those features in the example in FIG. 4 is applicable for the example in FIG. 5 where appropriate, and is not repeated here. Additionally, with particular reference to the example in FIG. 5, for TDRA 1 and TDRA 2, the network device 104 may configure the number of repetitions to be two and three, respectively. Therefore, the number of repetitions two and three are used to determine whether TDRA 2 and TDRA 3 are valid, respectively. The network device 104 may not configure the number of repetitions for TDRA 3, and correspondingly, the number of repetitions for TDRA 3 is one. Therefore, the number of repetitions of one may be used to determine whether TDRA 3 is valid.

Additionally, in the example in FIG. 5, for Slot 4, the user device 102 may determine whether two slots (e.g., slot 3 and slot 4) have an available resource for a PDSCH transmission with TDRA 1. All of the symbols of TDRA 1 (e.g., from symbol 1 to 4) in slot 3 and slot 4 are DL symbols. In other words, none of the symbols of TDRA 1 in slot 3 or in slot 4 is an UL symbol. Therefore, TDRA 1 is valid for slot 4 and is included in the first set. The user device 102 may determine whether the three slots (e.g., slot 2, slot 3 and slot 4) have available resources for PDSCH transmission with TDRA 2. All of the symbols of TDRA 2 (e.g., from symbol 3 to symbol 7) in slot 2, slot 3 and slot 4 are DL symbols or flexible symbols. In other words, none of the symbols of TDRA 2 in slot 2, in slot 3 or in slot 4 is an UL symbol. Therefore, TDRA 2 is valid for slot 4 and is included in the first set. The user device 102 may determine whether one slot (e.g., slot 4) has an available resource for a PDSCH transmission with TDRA 3. Symbols from symbol 9 to 13 in slot 4 are all UL symbols. In other words, at least one symbols of the TDRA 3 in slot 3 is an UL symbol. Therefore, TDRA 3 may not be valid for slot 4 and is not included in the first set. Therefore, the first set for slot 4 may include TDRA 1 and TDRA 2. Slot 4 may be included in the candidate slot set.

Similarly, for slot 5, TDRA 1 may be included in the first set since all of the symbols of TDRA 1 in slot 4 are DL symbols. TDRA 2 may be included in the first set since all of the symbols of TDRA 2 in slot 3 or slot 4 are DL symbols or flexible symbols. TDRA 3 may not be included in the first set since at least one symbol of TDRA 3 in slot 5 is an UL symbol. Therefore, the first set for slot 5 may include TDRA 1 and TDRA 2. Slot 5 may be included in the candidate slot set.

Similarly, for slot 6, TDRA 1 may not be included in the first set since at least one symbol of in each of slot 4 and slot 5 is an UL symbol. TDRA 2 may be included in the first set since all of the symbols of TDRA 2 in slot 4 are DL symbols or flexible symbols. TDRA 3 may not be included in the first set since at least one symbol of TDRA 3 in slot 6 is an UL symbol. Therefore, the first set for slot 6 may include only TDRA 2. Slot 6 may be included in the candidate slot set.

### Embodiment 3

In some implementations, the network may configure at least one TDRA table for unicast transmission for the user device 102. The at least one TDRA table may include a plurality of TDRA configurations for unicast transmission. A third number of repetitions may be determined for each of the plurality of TDRA configurations for unicast transmission. The third number of repetitions may be used to determine whether a corresponding TDRA configuration is valid. For a specific TDRA configuration for unicast transmission, the third number of repetitions may be the maximum (or largest) value of the number of repetitions that the network device 104 may configure for the specific TDRA configuration. The third number of the repetitions may be the maximum (or largest) one among the number of repetitions for dynamic scheduling of data channel transmission for unicast transmission (if any), the number of repetitions for semi-persistent scheduling of data channel transmission for unicast transmission (if any), and all of the numbers of repetitions included in the TDRA table for the specific TDRA configuration for unicast transmission (if any). For at least some implementations, the number of repetitions for dynamic scheduling of data channel transmission for unicast transmission, the number of repetitions for semi-persistent scheduling of data channel transmission for unicast transmission, and the numbers of repetitions included in the TDRA table for the specific TDRA configuration for unicast transmission may be configured by the network device 104.

For example, in the previous example where the network device 104 may configure both the number of repetitions for dynamic scheduling of a data channel (N1) and the TDRA table for the user device 102 for unicast transmission and the TDRA configuration (e.g., the number of OFDM symbols or the starting OFDM symbol) in the four rows are different, the third number of repetitions may be the larger of N1 and N3, the larger of N1 and N4, N1, and the larger of N1 and N5 for the TDRA configuration in the first row, the second row, the third row and the fourth row, respectively. The user device 102 may use the larger of N1 and N3, the larger of N1 and N4, N1, and the larger of N1 and N5 to determine whether the TDRA configuration in the first row, the second row, the third row and the fourth row are valid (or kept in the first set), respectively. Further assuming that the first row and the second row have the same TDRA configuration (e.g., the number of OFDM symbols or the starting OFDM symbol), then the third number of repetitions may be the largest one of N1, N3, and N4 for the TDRA configuration in the first row or the second row. The user device 102 may use the largest one of N1, N3, and N4 to determine whether the TDRA configuration in the first row or the second row is valid (or kept in the first set), respectively.

Additionally, in some implementations, the network device 104 may configure at least one TDRA table for multicast transmission for a user device 102. The at least one TDRA table may include a plurality of TDRA configurations for multicast transmission. A fourth number of repetitions may be determined for each of the plurality of TDRA configurations for multicast transmission. In a similar manner as for unicast transmission, the fourth number of repetitions may be used to determine whether the corresponding TDRA configuration is valid. For a specific TDRA configuration for multicast transmission, the fourth number of repetitions may be the maximum (or largest) value of the number of repetitions that the network device 104 configures for the specific TDRA configuration. The fourth number of the repetitions may be the maximum (or largest) one among the numbers of repetitions for dynamic scheduling of data channel transmission for multicast transmission (if any), the numbers of repetitions for semi-persistent scheduling of data channel transmission for multicast transmission (if any), and all of the numbers of repetitions included in the TDRA table for the specific TDRA configuration for multicast transmission (if any). In some implementations, the numbers of repetitions for dynamic scheduling of data channel transmission for multicast transmission, the numbers of repetitions for semi-persistent scheduling of data channel transmission for multicast transmission, and the numbers of repetitions included in the TDRA table for the specific TDRA configuration for multicast transmission may be configured by the network device 104.

Additionally, in some implementations, for a TDRA configuration included in the plurality of TDRA configurations for unicast transmission, the user device 102 may use the third number of repetitions to determine whether the TDRA configuration is valid. For a TDRA configuration included in the plurality of TDRA configurations for multicast transmission, the user device 102 may use the fourth number of repetitions to determine whether the TDRA configuration is valid.

Additionally, in some implementations, for a TDRA configuration included in the plurality of TDRA configurations for unicast transmission but not in the plurality of TDRA configurations for multicast transmission, the user device 102 may use the third number of repetitions to determine whether the TDRA configuration is valid. For a TDRA configuration included in the plurality of TDRA configurations for multicast transmission but not the plurality of TDRA configurations for the unicast transmission, the user device 102 may use the fourth number of repetitions to determine whether the TDRA configuration is valid. For a TDRA configuration included in both the plurality of TDRA configurations for unicast transmission and the plurality of TDRA configurations for multicast transmission, the user device 102 may use the larger of the third number of repetitions and the fourth number of repetitions to determine whether the TDRA configuration is valid.

### Embodiment 4

In some implementations, a HARQ-ACK codebook may be generated per codeblock group (CBG). For at least some of these implementations, one HARQ-ACK information bit may correspond to at least one CBG. In this case, the user device 102 may generate one HARQ-ACK information bit for one CBG. The network device 104 may configure one transport block (TB) to include one or more CBGs. The user device 102 may generate a plurality of HARQ-ACK information bits for one transport block and each of the plurality of HARQ-ACK information bits may correspond to each of the plurality of CBGs. In addition or alternatively, for a Type-1 or a Type-2 codebook, the user device 102 may generate a plurality of HARQ-ACK information bits for a DCI reception that is not associated with a PDSCH, or for a SLIV group. In addition or alternatively, for a Type-3 codebook, the user device 102 may generate a plurality of HARQ-ACK information bits for a HARQ process. The first bit may correspond to a first CBG, the second bit may correspond to a second CBG, and so on. For example, the network device 104 may configure one transport block to include Z CBGs (where Z is an integer). Correspondingly, the user device 102 may generate Z bits for one transport block.

Additionally, in some implementations, a HARQ-ACK codebook may be generated per TB. For at least some of these implementations, one HARQ-ACK information bit may correspond to at least one TB. In this case, the user device 102 may generate one HARQ-ACK information bit for one TB. In addition or alternatively, for a Type-1 or a Type-2 codebook, the user device 102 may generate one bit for a DCI reception that is not associated with a PDSCH, or for a SLIV group in the case of one PDSCH carrying one TB. The user device 102 may generate two bits for a DCI reception that is not associated with a PDSCH, or for a SLIV group in the case of one PDSCH carrying two TB. In addition or alternatively, for a Type-3 codebook, the user device 102 may generate one bit for a HARQ process in the case of one PDSCH carrying one TB. The user device 102 may generate two bits for a HARQ process in the case of one PDSCH carrying two TBs.

### Scenario 1

Additionally, in some implementations, the network device 104 may configure a CBG transmission for a unicast transmission. In addition or alternatively, the network device 105 may configure a TB transmission for a multicast transmission (e.g., the network device 104 may not configure a CBG transmission for the multicast transmission).

Additionally, in some implementations, the user device 102 may generate the HARQ-ACK information bits per CBG for a HARQ-ACK codebook. In addition or alternatively, the user device 102 may generate the HARQ-ACK information bits per TB for the HARQ-ACK codebook. In any of various implementations, the HARQ-ACK codebook may be a Type-1 codebook, a Type-2 codebook, or a Type-3 codebook.

Additionally, in some implementations, for a Type-1 codebook where the second HARQ-ACK feedback mode is configured, or for a Type-3 codebook, the user device 102 may generate the HARQ-ACK information bits per CBG or per TB. For a Type-1 codebook where FDM reception between multicast and unicast is configured, or for a Type-2 codebook, the user device 102 may generate the HARQ-ACK information bits per CBG for unicast transmission and generate the HARQ-ACK information bits per TB for multicast transmission. For a Type-1 codebook where the first HARQ-ACK feedback mode is configured, the user device 102 may generate the HARQ-ACK information bits per CBG for the candidate slot set associated with the third set and/or the fifth set (e.g., the candidate slot set is determined based on the third set and/or the fifth set). The user device 102 may generate the HARQ-ACK information bits per TB for the candidate slot set associated with the fourth set (e.g., the candidate slot set is determined based on the fourth set).

### Scenario 2

Additionally, in some implementations, the network device 104 may configure CBG transmission for the multicast transmission (or for at least one MBS). In addition or alternatively, the network device 104 may configure a TB transmission for the unicast transmission (e.g., the network device 104 may not configure a CBG transmission for the unicast transmission).

Additionally, in some embodiments, the user device 102 may generate the HARQ-ACK information bits per CBG for a HARQ-ACK codebook. In addition or alternatively, the user device 102 may generate the HARQ-ACK information bits per TB for the HARQ-ACK codebook. The HARQ-ACK codebook may be a Type-1 codebook, a Type-2 codebook or a Type-3 codebook, in any of various embodiments.

Additionally, in some embodiments, for a Type-1 codebook where the second HARQ-ACK feedback mode is configured, or for a Type-3 codebook, the user device 102 may generate the HARQ-ACK information bits per CBG or per TB. For a Type-1 codebook where FDM reception between multicast and unicast is configured, or for a Type-2 codebook, the user device 102 may generate the HARQ-ACK information bits per TB for unicast transmission and generate the HARQ-ACK information bits per CBG for multicast transmission. For a Type-1 codebook where the first HARQ-ACK feedback mode is configured, the user device 102 may generate the HARQ-ACK information bits per TB for the candidate slot set associated with the third set (e.g., the candidate slot set is determined based on the third set). The user device 102 may generate the HARQ-ACK information bits per CBG for the candidate slot set associated with the fourth set and/or fifth set (e.g., the candidate slot set is determined based on the fourth set and/or the fifth set).

### Scenario 3

Additionally, in some implementations, the network device 104 may configure CBG transmission for unicast transmission. The network device 104 may configure a first number C1 of CBG for unicast transmission. Also, the network device 104 may configure CBG transmission for multicast transmission. The network device 104 may configure at least a second number C2 of the CBG for multicast transmission. The user device 102 may generate the HARQ-ACK information bits per CBG.

Additionally, in some implementations, the user device 102 may generate the larger of the first number of CBG and the second number of CBG (e.g., the larger of C1 and C2) HARQ-ACK information bits for one transport block.

Additionally, in some implementations, for the Type-1 codebook where the second HARQ-ACK feedback mode is configured, or for the Type-3 codebook, the user device 102 may use the larger of the first number of CBG and the second number of CBG (e.g., the larger of C1 and C2) HARQ-ACK information bits for a transport block. For a Type-1 codebook where FDM reception between multicast and unicast is configured, or for a Type-2 codebook, the user device 102 may generate C1 bits for one transport block for unicast transmission and generate C2 bits for a transport block for multicast transmission. For a Type-1 codebook where the first HARQ-ACK feedback mode is configured, the user device 102 may generate C1 bits for one transport block for a candidate slot set associated with the third set (e.g., the candidate slot set is determined based on the third set). Additionally, the user device 102 may generate C2 bits for one transport block for the candidate slot set associated with the fourth set (e.g., the candidate slot set is determined based on the fourth set). The user device 102 may generate the larger of C1 and C2 bits for one transport block for the candidate slot set associated with the fifth set (e.g., the candidate slot set is determined based on the fifth set).

Additionally, in some implementations, the network device 104 may configure a CBG transmission or a TB transmission for both multicast transmission and unicast transmission. From the perspective of the user device 102, the user device 102 may not expect the network device 104 to configure different transmission modes for unicast transmission and multicast transmission. The transmission may include at least CBG transmission and TB transmission. In addition, the network device 104 may configure the same number of CBGs for both multicast transmission and unicast transmission. From the perspective of the user device 102, the user device 102 may not expect the network device 104 to configure different numbers of CBGs for unicast transmission and multicast transmission.

### Embodiment 5

In some embodiments, the network device 104 may configure a third configuration for the user device 102. Alternatively, the network device 104 may transmit the third configuration to the user device 102. The third configuration may include at least a common frequency resource (CFR). One CFR may be configured within a bandwidth part (BWP). The network device 104 may transmit a data channel (e.g., downlink data channel) to the user device 102. In addition or alternatively, the user device 102 may transmit a data channel (e.g., uplink data channel). The CFR may be for multicast transmission for the user device 102. The user device 102 may use the CFR in the active BWP (or BWP with the smallest or largest BWP ID) to determine the limited buffer rate matching (LBRM) transport block size (TBS) for the data channel. More specifically, the user device 102 may use the CFR in the active BWP (or BWP with the smallest or largest BWP ID) to determine the number of PRB for limited buffer rate matching (LBRM) transport block size (TBS). Additionally or alternatively, the user device 102 may use the largest CFR (or the CFR with the greatest number of PRB) to determine LBRM TBS for the data channel. More specifically, the user device 102 may use the largest CFR (or the CFR with the greatest number of PRB) to determine the number of PRB used for LBRM TBS. Alternatively, the user device 102 may use the CFR in the active BWP (or BWP with smallest or largest BWP ID) or the largest CFR (or the CFR with the greatest number of PRB) to determine LBRM TBS for the data channel for multicast.

Additionally, in some implementations, the network device 104 may configure one CFR for the user device 102 for broadcast only. The user device 102 may use the one CFR to determine LBRM TBS for the data channel for broadcast. More specifically, the user device 102 may use the CFR to determine the number of PRB used for LBRM TBS for the data channel for broadcast.

Additionally, in some implementations, the LBRM TBS may be determined by a maximum number of multiple input multiple output (MIMO) layers, a highest modulation order, a maximum code rate, and/or a specific resource size. The specific resource size may be determined based on the frequency resource. For example, the resource size (e.g., the number of REs) may be X*N, where X is the number of REs in a physical resource block (PRB) that may be used for data channel transmission and N is the number of physical resource blocks (PRBs) used for LBRM. For at least some of these implementations, X is a constant or fixed value, as used by the user device 102 and/or other communication nodes in the wireless communication system 100. An example for X is 156, although other values or constants may be used. Additionally, the value of N may depend on the CFR size (or the number of PRB of CFR). In event that the network 104 configures one or more CFR, the CFR in the active BWP (or BWP with the smallest or the largest BWP ID) or the largest CFR (or the CFR with the greatest number of PRB) may be used to determine the value of N. Table 1 below shows the value N depending on the number of PRBs of the CFR in the wireless communication system 100. For example, Table 1 lists a plurality of candidate values for N: {32, 66, 107, 135, 162, 217, 273}. Each candidate value corresponds to a respective range of number of PRBs of CFR in the active BWP (or BWP with smallest or largest BWP ID) or the largest CFR (or the CFR with the greatest number of PRB). In operation, the user device 102 may identify a number of PRBs of the CFR or a maximum number of PRBs across all configured CFR. In turn, the user device 102 may identify a range among the plurality of ranges of maximum number of PRBs in which the identified number of PRB of the CFR or maximum number of PRBs falls. Then, the user device 102 may determine the value of N that corresponds to the identified range of the number of PRB of the CFR or the maximum of PRBs, and select that value for the value of N for the resource size. As an example, where the number of PRBs of the CFR in the active BWP is less than 33, N is 32 according to Table 1. As another example, where the maximum number of PRBs across all the configured CFR is greater than or equal to 33, and smaller than or equal to 66, N is 66 according to Table 1.

TABLE 1

| The number of PRBs of the CFR | N |
|---|---|
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: sending, by a network device, at least one of a first configuration for a unicast transmission or a second configuration for a multicast transmission to a user device; sending, by the network device, at least one of the unicast transmission or the multicast transmission to the user device; and receiving, by the network device, a hybrid automatic repeat request (HARQ)-acknowledgment (ACK) comprising information bits determined based on the first configuration or the second configuration.

A second aspect includes a method for wireless communication that includes: receiving, by a user device, at least one of a first configuration for a unicast transmission or a second configuration for a multicast transmission; receiving, by the user device, at least one of the unicast transmission or the multicast transmission; generating, by the user device, a hybrid automatic repeat request (HARQ)-acknowledgement (ACK) for the unicast transmission or for the multicast transmission, the HARQ-ACK comprising information bits determined based on the first configuration or the second configuration; and transmitting, by the user device, the HARQ-ACK.

A third aspect includes any of the first or second aspects, and further includes wherein at least one of the first configuration or the second configuration includes one or more numbers of repetitions for a physical downlink shared channel (PDSCH), wherein each of the one or more numbers of repetitions of the second configuration is for a multicast service.

A fourth aspect includes the third aspect, and further includes wherein each of the one or more numbers of repetitions includes at least one of: a number of repetitions for dynamic scheduling of the PDSCH; a number of repetitions for a semi-persistent PDSCH; or a number of repetitions included in a time domain resource allocations (TDRA) table.

A fifth aspect includes any of the third or fourth aspects, and further includes: determining, by the user device, whether a time domain resource allocations (TDRA) configuration is included in a TDRA set for a slot based on N consecutive slots.

A sixth aspect includes the fifth aspect, and further includes wherein determining whether the TDRA configuration is included in the TDRA set for the slot based on N consecutive slots comprises: determining that the TDRA configuration is not included in the TDRA set in response to at least one symbol of the TDRA configuration in each of N consecutive slots being an uplink symbol; and determining that the TDRA configuration is included in the TDRA set in response to at least one symbol of the TRDRA configuration in each of N consecutive slots not being an uplink symbol, wherein the slot is a last slot of the N consecutive slots.

A seventh aspect includes the sixth aspect, and further includes wherein one of: N is a maximum value among all numbers of repetitions in the first configuration for HARQ-ACK information bit generation for unicast transmissions and is a maximum value among all numbers of repetitions in the second configuration for HARQ-ACK information bit generation for multicast transmissions; N is a maximum value among all numbers of repetitions in the first configuration and the second configuration for HARQ-ACK information bit generation; N is a maximum value among all numbers of repetitions in the first configuration and the slot is determined based on a time interval that belongs to a first time interval set for the unicast transmissions and does not belong to a second time interval set for the multicast transmissions; N is a maximum value among all numbers of repetitions in the second configuration and the slot is determined based on a time interval that belongs to the second time interval set for the multicast transmissions and does not belong to the first time interval set for the unicast transmissions; N is a maximum value among all numbers of repetitions in the first configuration and the second configuration, and the slot is determined based on a time interval that belong to the first time interval set for the unicast transmissions and also belong to the second time interval set for the multicast transmissions; or N is a maximum value among all numbers of repetitions for the TDRA configuration.

An eight aspect includes any of the first through seventh aspects, and further includes wherein at least one of the first configuration or the second configuration includes at least one of: a codeblock group (CBG) transmission, a transport block (TB)-based transmission, or a number of CBGs.

A ninth aspect includes the eighth aspect, and further includes wherein the user device generates the information bits of the HARQ-ACK per CBG in response to the first configuration or the second configuration comprising the CBG transmission.

A tenth aspect includes the eighth aspect, and further includes wherein the user device generates the information bits of the HARQ-ACK per TB in response to the first configuration or the second configuration comprising the TB transmission.

An eleventh aspect includes the eighth aspect, and further includes wherein the user device generates the information bits of the HARQ-ACK per CBG for a slot determined based on a time interval that belongs to the first time interval set for the unicast transmissions.

A twelfth aspect includes the eighth aspect, and further includes wherein the user device generates the information bits of the HARQ-ACK bits per TB for a slot determined based on a time interval that belongs to the second time interval set for the multicast transmissions and does not belong to the first time interval set for the unicast transmission.

A thirteenth aspect includes a wireless communications apparatus that includes a processor and a memory, wherein the processor is configured to read code from the memory to implement any of the first through twelfth aspects.

A fourteenth aspect includes a computer program product that includes a computer-readable program medium comprising code stored thereupon, the code, when executed by a processor, causing the processor to implement any of the first through twelfth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a user device from a network device, a configuration that comprises at least one common frequency range (CFR) for multicast and at least one bandwidth part (BWP), wherein the CFR is within the BWP; and
receiving, by the user device from the network device, a data channel,
wherein a limited buffer rate matching (LBRM) transport block size (TBS) of the data channel is determined based on the CFR in an active BWP.

2. The method of claim 1, wherein the LBRM TBS is determined based on a maximum number of multiple input multiple output (MIMO) layers, a highest modulation order, a maximum code rate, and a resource size,
wherein the resource size is determined based on the CFR in the active BWP.

3. The method of claim 1, wherein the data channel comprises a physical downlink shared channel (PDSCH).

4. A wireless communications apparatus comprising
a memory storing a plurality of instructions; and
at least one processor configured to execute the plurality of instructions, wherein upon execution of the plurality of instructions, the at least one processor is configured to:
receive, from a network device, a configuration that comprises at least one common frequency range (CFR) for multicast and at least one bandwidth part (BWP), wherein the CFR is within the BWP; and
receive, from the network device, a data channel,
wherein a limited buffer rate matching (LBRM) transport block size (TBS) of the data channel is determined based on the CFR in an active BWP.

5. The apparatus of claim 4, wherein the LBRM TBS is determined based on a maximum number of multiple input multiple output (MIMO) layers, a highest modulation order, a maximum code rate, and a resource size,
wherein the resource size is determined based on the CFR in the active BWP.

6. The apparatus of claim 4, wherein the data channel comprises a physical downlink shared channel (PDSCH).

7. A non-transitory computer-readable storage medium storing a plurality of instructions executable by at least one processor, wherein the plurality of instructions, when executed by the at least one processor, is configured to cause the at least one processor to perform the method of claim 1.

8. A method for wireless communication, the method comprising:
transmitting, by a network device to a user device, a configuration that comprises at least one common frequency range (CRF) for multicast and at least one bandwidth part (BWP), wherein the CFR is within the BWP; and
transmitting, by the network device to the user device, a data channel,
wherein a limited buffer rate matching (LBRM) transport block size (TBS) of the data channel is determined based on the CFR in an active BWP.

9. The method of claim 8, wherein the LBRM TBS is determined based on a maximum number of multiple input multiple output (MIMO) layers, a highest modulation order, a maximum code rate, and a resource size,
wherein the resource size is determined based on the CFR in the active BWP.

10. The method of claim 8, wherein the data channel comprises a physical downlink shared channel (PDSCH).

11. A wireless communications apparatus comprising a memory storing a plurality of instructions, and at least one processor configured to execute the plurality of instructions, wherein upon execution of the plurality of instructions, the at least one processor is configured to perform the method of claim 8.

12. A non-transitory computer-readable storage medium storing a plurality of instructions executable by at least one processor, wherein when executed by the at least one processor, the plurality of instructions are configured to cause the at least one processor to perform the method of claim 8.
